(19) United States
(12) Patent Application Publication
(10) Pub. No.: US 2015/0303433 A1
(43) Pub. Date: Oct. 22, 2015

(54) RECHARGEABLE BATTERY MODULE

(71) Applicant: SAMSUNG SDI CO., LTD., Yongin-si (KR)

(72) Inventors: Min-Yeol HAN, Yongin-si (KR); Hae-Kwon YOON, Yongin-si (KR); Seung-Bok LEE, Yongin-si (KR); Yong-Hee YUN, Yongin-si (KR)

(21) Appl. No.: 14/564,194

(22) Filed: Dec. 9, 2014

(30) Foreign Application Priority Data
Apr. 16, 2014 (KR) 10-2014-0045607

(51) Int. Cl. H01M 2/20

(52) U.S. Cl. CPC H01M 2/206; H01M 2220/20

(57) ABSTRACT

A rechargeable battery module includes a plurality of unit cells adjacent to each other, each unit cell including a rechargeable battery with a first electrode terminal, a second electrode terminal, and a case electrically connected to the first electrode terminal, and a conductive member electrically connected to a second electrode terminal of one of the unit cells of the plurality of unit cells, the conductive member including first conductive plates at outermost sides of the unit cells and a plurality of second conductive plates between the unit cells.

### CROSS-REFERENCE TO RELATED APPLICATION

Korean Patent Application No. 10-2014-0045607, filed on Apr. 16, 2014, in the Korean Intellectual Property Office, and entitled: “Rechargeable Battery Module,” is incorporated by reference herein in its entirety.

### BACKGROUND

1. Field

The described technology relates generally to a rechargeable battery module with improved safety.

2. Description of the Related Art

A rechargeable battery differs from a primary battery in that it can be repeatedly charged and discharged, while the latter is incapable of being recharged. A low-capacity rechargeable battery may be used in small portable electronic devices, e.g., mobile phones, notebook computers, and camcorders, while a high-capacity rechargeable battery may be used as a power source for driving motors, e.g., of a hybrid vehicle and an electric vehicle.

The rechargeable battery may be used in small electronic devices as a single cell battery or in motor-driving power sources, etc., as a battery module in which a plurality of cells are electrically connected. For example, electrode terminals of cell batteries may be connected in series or parallel through bus bars so as to form a rechargeable battery module.

When conductive foreign objects, e.g., a nail, an awl, etc., enter the rechargeable battery module, a short circuit may occur therein. When a short circuit occurs, the internal temperature of the rechargeable battery rapidly increases, thereby leading to ignition or explosion risk of the rechargeable battery.

### SUMMARY

An exemplary embodiment of the described technology relates generally to a rechargeable battery module with improved safety against conductive foreign objects penetrating therein.

An exemplary embodiment provides a rechargeable battery module including unit cells adjacently disposed to each other, wherein each unit cell consists of a rechargeable battery including a first electrode terminal, a second electrode terminal, and a case electrically connected to the first electrode terminal; and a conductive member electrically connected to the second electrode terminal and including first conductive plates disposed at outermost sides of the unit cells and a plurality of second conductive plates disposed between the unit cells.

The conductive member may include lateral side-connecting plates that are formed to be bent from and connect the first and second conductive plates.

The lateral side-connecting plates may be formed with a terminal connecting portion that upwardly protrudes to be fixed to the second electrode terminal, and the lateral side-connecting plates may connect the first and second conductive plates in series.

The first conductive plates may be formed with a terminal connecting portion that upwardly protrudes to be fixed to the second electrode terminal, and insulating layers may be formed on surfaces of the first conductive plates that face the unit cells.

Opposite surfaces of the second conductive plates may be formed with insulating layers, and at least one of the second conductive plates may be formed with an avoidance hole.

The conductive member may include a third conductive plate that is disposed between the second conductive plates, and the second conductive plates may be formed with avoidance holes while the third conductive plate may not be formed with an avoidance hole.

The conductive member may include a third conductive plate that is disposed between the second conductive plates, and the third conductive plate may be formed with an avoidance hole while the second conductive plates may not be formed with avoidance holes.

The unit cells may include a first unit cell that is provided with an inversely deformed short-circuit member according to varying internal pressure, and a second unit cell that is not provided with the short-circuit member.

The conductive member may include a short-circuit connecting portion that is disposed above the short-circuit member to contact the short-circuit member when the short-circuit member is deformed, and the short-circuit connecting portion may protrude from the first conductive plates.

A surface of the short-circuit connecting portion facing the short-circuit member may be formed with an insulating layer, the insulating layer may be formed with an opening that exposes the short-circuit connecting portion, and heights of the lateral side-connecting plates may be formed to be smaller than those of the first conductive plates.

The exemplary embodiment provides the conductive member to lateral sides of all unit cells, electrically connects the conductive member with the first electrode terminal, and electrically connects the cases of the unit cells to the second electrode terminal.

### BRIEF DESCRIPTION OF THE DRAWINGS

Features will become apparent to those of ordinary skill in the art by describing in detail exemplary embodiments with reference to the attached drawings, in which:

FIG. 1 illustrates a perspective view of a rechargeable battery module according to a first exemplary embodiment.

FIG. 2 illustrates an exploded perspective view of the rechargeable battery module in FIG. 1.

FIG. 3 illustrates a perspective view of a first unit cell applicable to FIG. 1.

FIG. 4 illustrates a cross-sectional view along line IV-IV of FIG. 3.

FIG. 5 illustrates a bottom side perspective view of a short-circuit connecting portion of a conductive member according to the first exemplary embodiment.

FIG. 6 illustrates a top plan view of the rechargeable battery module in FIG. 1.

FIG. 7 illustrates a perspective view of a conductive member according to a second exemplary embodiment.

FIG. 8 illustrates a perspective view of a conductive member according to a third exemplary embodiment.

FIG. 9 illustrates a perspective view of a conductive member according to a fourth exemplary embodiment.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. In addition, it will also be understood that when a layer is referred to as being “between” two layers, it can be the only layer between the two layers, or one or more intervening layers may also be present. Like reference numerals refer to like elements throughout.

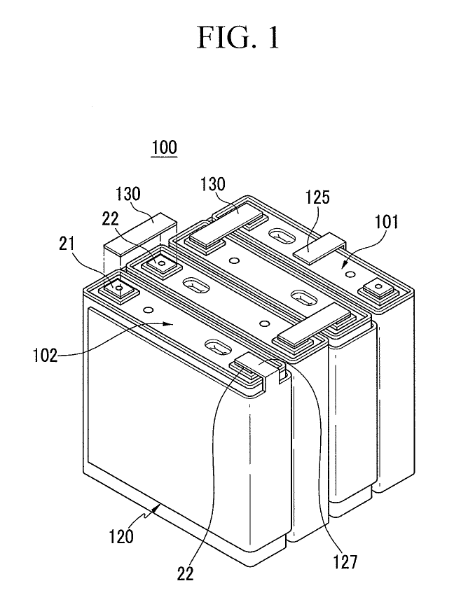

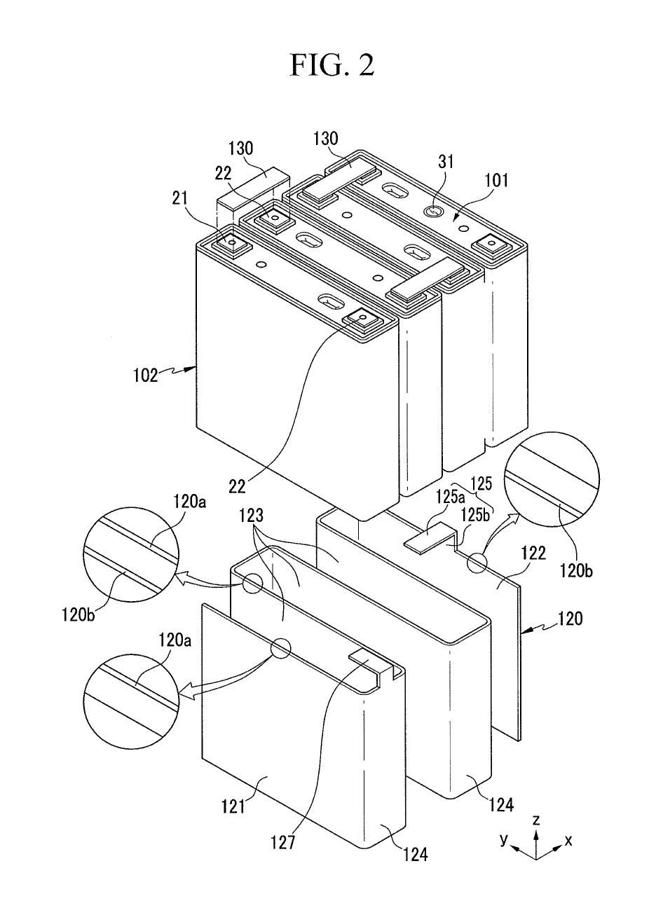

FIG. 1 illustrates a perspective view of a rechargeable battery module according to a first exemplary embodiment, and FIG. 2 illustrates an exploded perspective view of the rechargeable battery module in FIG. 1.

Referring to FIGS. 1 and 2, a rechargeable battery module 100 according to the first exemplary embodiment may include unit cells 101 and 102 containing rechargeable batteries, a conductive member 120 having conductive plates 121, 122, and 123 that are disposed at outermost sides of and between the unit cells 101 and 102, and bus bars 130 that electrically connect the unit cells 101 and 102.

The unit cells 101 and 102 include first unit cells 101 that are provided with a short-circuit member 31 and second unit cells 102 that are not provided with the short-circuit member 31, respectively. For example, the unit cells 101 and 102 may be alternately arranged. In another example, the rechargeable battery module 100 includes at least one first unit cell 101, and the first unit cell 101 may be disposed at an outermost side or between second unit cells 102.

The bus bar 130 has a plate shape, and is fixed between first and second terminals of the unit cells to connect the unit cells in series. However, example embodiments are not limited thereto, e.g., the unit cells may be connected in series or in parallel.

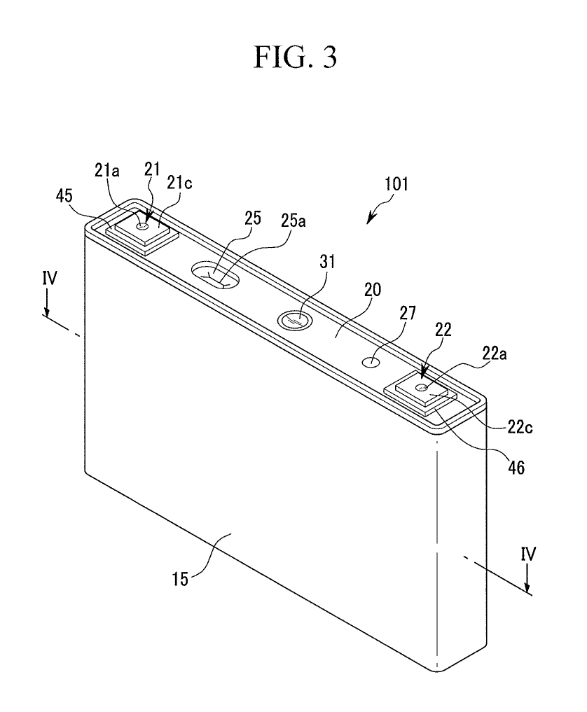

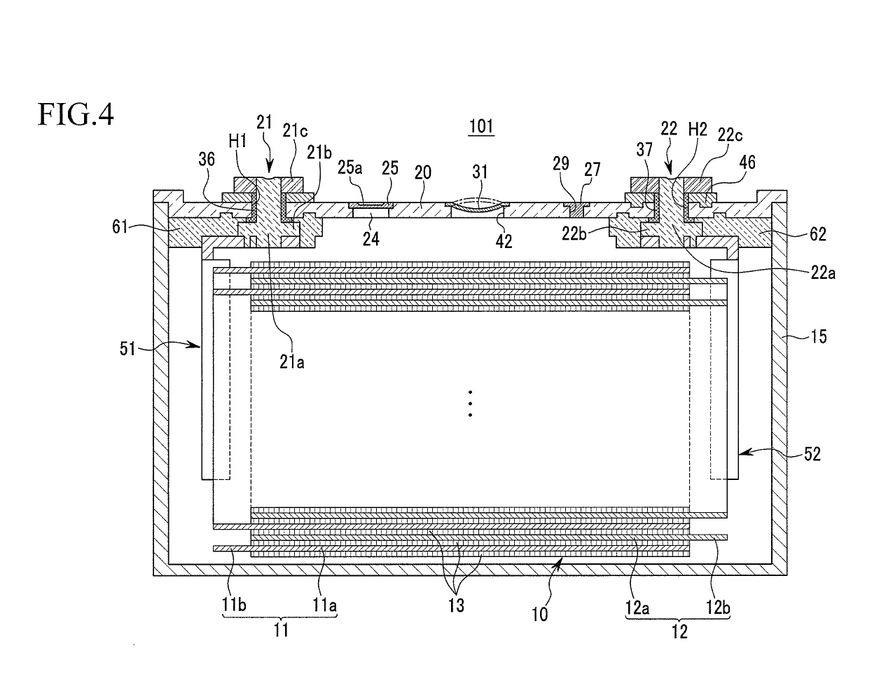

An exemplary unit cell according to example embodiments will be described hereinafter with reference to FIGS. 3-4. FIG. 3 illustrates a perspective view of the first unit cell 101, and FIG. 4 illustrates a cross-sectional view along line IV-IV of FIG. 3. It is noted that since the second unit cell 102 has the same configuration as the first unit cell 101, except for the short-circuit member 31, the description of the first unit cell 101 will also apply to the second unit cell 102.

Referring to FIGS. 3-4, the first unit cell 101 may include an electrode assembly 10 for charging and discharging a current, a case 15 for accommodating the electrode assembly 10, a cap plate 20 combined to an opening of the case 15, and a first electrode terminal 21 (hereinafter referred to as a “positive terminal”) and a second electrode terminal 22 (hereinafter referred to as a “negative terminal”) that are provided in the cap plate 20.

For example, after a first electrode 11 (hereinafter referred to as a “positive electrode”) and a second electrode 12 (hereinafter referred to as a “negative electrode”) are disposed at opposite sides of a separator 13, which is an insulator, the positive electrode 11, the separator 13, and the negative electrode 12 may be spirally wound in a jelly-roll state so as to form the electrode assembly 10. The positive and negative electrodes 11 and 12 respectively include coated regions 11a and 12a, where an active material is coated on current collectors made of a metal plate, and uncoated regions 11b and 12b, where an active material is not coated thereon and thus are formed as exposed current collectors. The uncoated region 11b of the positive electrode 11 is formed at one end of the positive electrode 11 along the wound positive electrode 11. The uncoated region 12b of the negative electrode 12 is formed at one end of the negative electrode 12 along the wound negative electrode 12. The uncoated regions 11b and 12b are respectively disposed at opposite ends of the electrode assembly 10.

For example, the case 15 may be substantially formed as a cuboid in which a space for accommodating the electrode assembly 10 and an electrolyte solution is set, and is formed with the opening that connects inner and outer spaces. The opening allows the electrode assembly 10 to be inserted into the case 15.

The cap plate 20 has a plate shape, and is provided in the opening of the case 15 to seal the case 15. For example, the case 15 and the cap plate 20 may be formed of aluminum such that they can be welded to each other.

In addition, the cap plate 20 is provided with an electrolyte injection opening 29, a vent hole 24, and terminal holes H1 and H2. After combining the cap plate 20 to the case 15, the electrolyte injection opening 29 allows the electrolyte solution to be injected into the case 15. After being injected with the electrolyte solution, the electrolyte injection opening 29 is sealed with a sealing cap 27.

The vent hole 24 is sealed with a vent plate 25 so as to discharge internal pressure of the unit cells 101 and 102. The vent plate 25 is ruptured to open the vent hole 24 when the internal pressure of the unit cells 101 and 102 reaches a predetermined pressure. The vent plate 25 is provided with a notch 25a that induces the rupture.

The positive and negative terminals 21 and 22 are provided in the terminal holes H1 and H2 of the cap plate 20, and are electrically connected to the electrode assembly 10. That is, the positive terminal 21 is electrically connected to the positive electrode 11 of the electrode assembly 10, while the negative terminal 22 is electrically connected to the negative electrode 12 of the electrode assembly 10. Thus, the electrode assembly 10 is drawn out of the case 15 through the positive and negative terminals 21 and 22.

The positive terminal 21 includes a rivet terminal 21a that is provided in the terminal hole H1 of the cap plate 20, a flange 21b that is integrally and widely formed with the rivet terminal 21a inside of the cap plate 20, and a plate terminal 21c that is disposed outside of the cap plate 20 to be connected to the rivet terminal 21a by riveting or welding. Positive electrode gaskets 36 are respectively provided between the rivet terminal 21a of the positive terminal 21 and the inner side of the terminal hole H1 of the cap plate 20 so as to seal and electrically insulate between the rivet terminal 21a of the positive terminal 21 and the cap plate 20. The positive electrode gaskets 36 are provided to be further elongated between the flange 21b and the cap plate 20 to further seal and electrically insulate between the flange 21b and the cap plate 20. That is, the positive electrode gaskets 36 are installed together with the positive terminal 21 in the cap plate 20 so as to prevent the electrolyte solution from leaking through the terminal hole H1.

A positive electrode lead tab 51 electrically connects the positive terminal 21 with the positive electrode 11 of the electrode assembly 10. That is, the positive electrode lead tab 51 is combined to a lower end of the rivet terminal 21a and the lower end is caulked, such that the positive electrode lead tab 51 is both supported by the flange 21b and connected to the lower end of the rivet terminal 21a.

A positive electrode insulating member 61 is provided between the positive electrode lead tab 51 and the cap plate 20 to insulate them. In addition, the positive electrode insulating member 61 is combined to the cap plate 20 at one side while enclosing the positive electrode lead tab 51, the rivet terminal 21a, and the flange 21b at the other side, thereby stabilizing a connecting structure therebetween.

A top plate 45 is provided between the plate terminal 21c and the cap plate 20, and the top plate 45 electrically connects the plate terminal 21c with the cap plate 20. The top plate 45 is interposed between the plate terminal 21c and the cap plate 20, and is penetrated by the rivet terminal 21a. Accordingly, the cap plate 20 and the case 15 are positively charged.

The negative terminal 22 includes a rivet terminal 22a that is provided in the terminal hole H2 of the cap plate 20, a flange 22b that is integrally and widely formed with the rivet terminal 22a inside of the cap plate 20, and a plate terminal 22c that is disposed outside of the cap plate 20 to be connected to the rivet terminal 22a by riveting or welding. Negative electrode gaskets 37 are provided between the rivet terminal 22a of the negative terminal 22 and the inner side of the terminal hole H2 of the cap plate 20 so as to seal and electrically insulate between the rivet terminal 22a of the negative terminal 22 and the cap plate 20. The negative electrode gaskets 37 are provided to be further elongated between the flange 22b and the cap plate 20 to further seal and electrically insulate between the flange 22b and the cap plate 20. That is, the negative electrode gaskets 37 are installed together with the negative terminal 22 in the cap plate 20 so as to prevent the electrolyte solution from leaking through the terminal hole H2.

A negative electrode lead tab 52 electrically connects the negative terminal 22 with the negative electrode 12 of the electrode assembly 10. That is, the negative electrode lead tab 52 is combined to a lower end of the rivet terminal 22a and the lower end is caulked, such that the negative electrode lead tab 52 is both supported by the flange 22b and connected to the lower end of the rivet terminal 22a.

A negative electrode insulating member 62 is provided between the negative electrode lead tab 52 and the cap plate 20 to insulate them. In addition, the negative electrode insulating member 62 is combined to the cap plate 20 at one side while enclosing the negative electrode lead tab 52, the rivet terminal 22a, and the flange 22b at the other side, thereby stabilizing a connecting structure therebetween.

An upper insulating plate 46 is provided between the plate terminal 22c and the cap plate 20, and the upper insulating plate 46 electrically insulates the plate terminal 22c from the cap plate 20. The upper insulating plate 46 is interposed between the plate terminal 22c and the cap plate 20, and is penetrated by the rivet terminal 22a.

Meanwhile, the cap plate 20 is formed with a short-circuit hole 42, and the short-circuit hole 42 is provided with the short-circuit member 31 that is inversely deformed according to a change in the internal pressure of the case 15. The short-circuit member 31 is formed to have a plate-like shape and to be downwardly convexly curved. The short-circuit member 31 is inversely deformed to be upwardly convex when the internal pressure of the case 15 increases.

Referring back to FIG. 2, the conductive member 120 includes first conductive plates 121 and 122 that are disposed at outermost sides of the unit cells 101 and 102, a plurality of second conductive plates 123 that are disposed between the unit cells 101 and 102, and lateral side-connecting plates 124 that interconnect the first conductive plates 121 and 122 and the second conductive plates 123. For example, as illustrated in FIG. 2, the first conductive plates 121 and 122 are spaced apart from each other along the x-axis to define outermost plates, such that all the first and second unit cells 101 and 102 may be positioned between the two outermost plates, i.e., between the two first conductive plates 121 and 122. As further illustrated in FIG. 2, the second conductive plates 123 may be disposed among the unit cells 101 and 102, e.g., each second conductive plate 123 may be disposed between two unit cells adjacent to each other along the x-axis. For example, one second conductive plate 123 may be disposed between two adjacent second unit cells 102. In another example, one second conductive plate 123 may be disposed between first and second unit cells 101 and 102 adjacent to each other.

As further illustrated in FIG. 2, the lateral side-connecting plates 124 interconnect the first conductive plates 121 and 122 and the second conductive plates 123. For example, the lateral side-connecting plates 124 may be, e.g., in the xz-plane, perpendicular to the first and second conductive plates 121 through 123, and may connect every two adjacent ones of the first and second conductive plates 121 through 123. For example, as illustrated in FIG. 2, the lateral side-connecting plates 124 may connect every two adjacent ones of the first and second conductive plates 121 through 123 at alternating sides to shape the conductive member 120 into a zigzag shape.

The first conductive plates 121 and 122 and the second conductive plates 123 are formed to be rectangular, e.g., in the yz-plane. In addition, the first conductive plates 121 and 122 and the second conductive plates 123 are formed of a metal, e.g., silver or aluminum. The first conductive plates 121 and 122 are disposed at the outermost sides of the unit cells 101 and 102, and surfaces of the first conductive plates 121 and 122 that face the unit cells 101 and 102 are formed with insulating films 120a and 120b. The second conductive plates 123 are disposed to face wide front sides of the unit cells 101 and 102 therebetween, and opposite surfaces of the second conductive plates 123 are formed with the insulating films 120a and 120b. That is, e.g., only, metal surfaces of the first and second conductive plates 121 through 123 that face the unit cells 101 and 102 are coated with the insulating films 120a and 120b.

The first conductive plates 121 and 122 and the second conductive plates 123 are disposed in parallel with each other, and the lateral side-connecting plates 124 are formed to be bent from the first conductive plates 121 and 122 and the second conductive plates 123. The lateral side-connecting plates 124 are substantially bent to be perpendicular to the first conductive plates 121 and 122 and the second conductive plates 123.

In detail, as shown in FIG. 2, the lateral side-connecting plates 124 are formed with a terminal connecting portion 127 that upwardly protrudes to be fixed to the negative terminal 22 of a unit cell. For example, the terminal connecting portion 127 may have an inverted L-shape that extends from one of the lateral side-connecting plates 124 to overlap a portion of and connect to the negative terminal 22 of a unit cell. For example, the terminal connecting portion 127 is fixed to the negative terminal 22 of the second unit cell 102 by welding, and thus the conductive member 120 is negatively charged.

Further, as illustrated in FIG. 2, the first conductive plate 122 is formed with a short-circuit connecting portion 125. The short-circuit connecting portion 125 protrudes from the first conductive plate 122 to be disposed above the short-circuit member 31. For example, the short-circuit connecting portion 125 may have an inverted L-shape that extends from the first conductive plate 122 to overlap the short-circuit member 31 of the first unit cell 101.

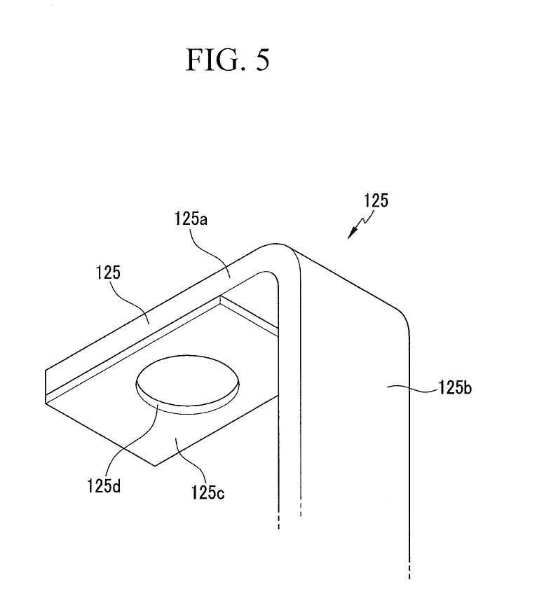

In detail, as illustrated in FIG. 5, the short-circuit connecting portion 125 includes a connecting protrusion 125b that upwardly protrudes from the first conductive plate 122, and a short-circuit protrusion 125a that is bent from the connecting protrusion 125b to face and overlap the short-circuit member 31. The short-circuit protrusion 125a is spaced apart from the short-circuit member 31 along the z-axis to be disposed above the short-circuit member 31. An insulating layer 125c is formed on a surface of the short-circuit protrusion 125a that faces the short-circuit member 31. The insulating layer 125c may be formed of an insulating film or a coating layer. An opening 125d is formed at, e.g., the center of, the insulating layer 125c, and a bottom surface of the short-circuit protrusion 125a is exposed through the opening 125d.

When the short-circuit member 31 of the first unit cell 101 is inversely deformed by the increased internal pressure of the first unit cell 101, the short-circuit member 31 upwardly protrudes and passes through the opening 125d so as to contact the short-circuit protrusion 125a. Accordingly, e.g., only, when the internal pressure of the first unit cell 101 reaches a predetermined value and the short-circuit member 31 is inverted upwardly, the negatively charged conductive member 120, i.e., via the contact between the terminal connecting portion 127 and the negative terminal 22, and the positively charged short-circuit member 31 contact each other, i.e., via the short-circuit connecting portion 125, to cause an external short-circuit. When the external short-circuit occurs, the current charged in the electrode assembly 10 can be discharged.

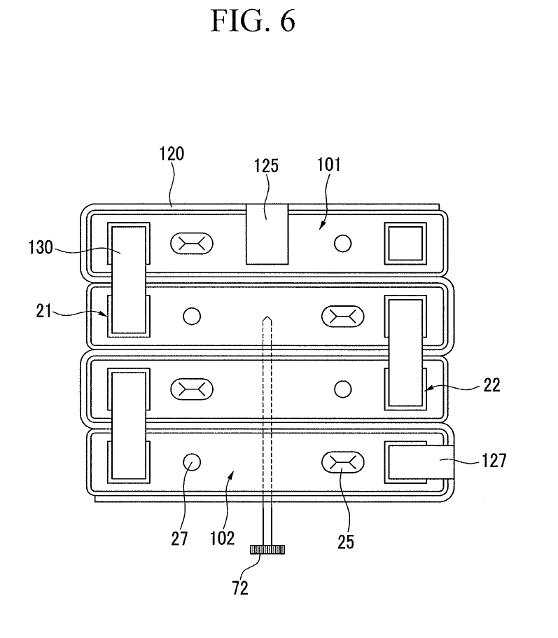

FIG. 6 illustrates a top plan view of the rechargeable battery module in FIG. 1.

Referring to FIG. 6, as described above, the case 15 is positively charged and the conductive member 120 is negatively charged. If a conductive foreign object 72, e.g., a nail, enters the first unit cell 101 or the second unit cell 102 from one side of the rechargeable battery module 100, the case 15 and the conductive member 120 are electrically connected to each other to cause an external short-circuit.

In detail, if the conductive foreign object 72 penetrates a plurality of unit cells 101 and 102 at a high speed, the conductive foreign object 72 directly and electrically contacts the first conductive plates 121 and 122 and the second conductive plates 123, such that the charged current in the unit cells 101 and 102 can be more rapidly discharged through one of the first and second conductive plates 121 through 123. Accordingly, a voltage drop in the electrode assembly 10 of the unit cells 101 and 102 can be more effectively achieved.

If the conductive plates are only at the outermost sides of the unit cells, i.e., if the rechargeable battery module 100 includes only the first conductive plates 121 and 122 (without the second conductive plates 123), charged current in inner unit cells can be discharged through the conductive foreign object 72 that directly contacts the electrode assembly, rather than through the conductive member. When the charged current discharged through the conductive foreign object 72, i.e., when the short-circuit current flows between the conductive foreign object 72 and the electrode assembly 10, a large amount of heat is generated due to high resistance, thereby causing a rapid increase in internal temperature and potential ignition or explosion risk.

Therefore, according to example embodiments, the conductive member 120 includes the second conductive plates 123 between the unit cells 101 and 102, so the charged current in the inner-disposed unit cells 101 and 102 can be more rapidly discharged. In addition, each unit cell may be further provided with an internal conductive member (not shown) having negative polarity inside of the case.

Therefore, according to example embodiments, even if the conductive foreign object penetrates when a fuse is not cut off, the case 15 having positive polarity is short-circuited with the internal conductive member (not shown) having negative polarity such that a minimal state of charge (SOC) is decreased. That is, the rechargeable battery module can be less affected by the conductive foreign object that can penetrate therein.

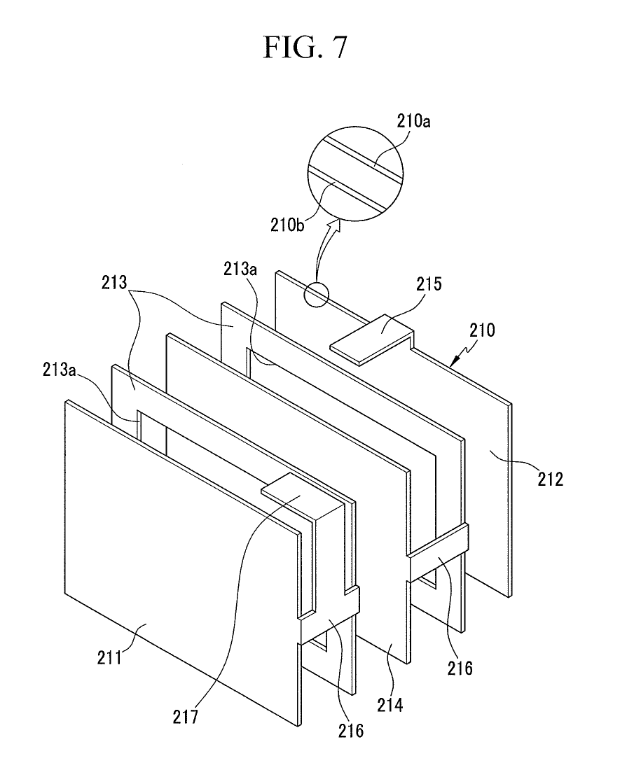

FIG. 7 illustrates a perspective view of a conductive member according to a second exemplary embodiment.

Referring to FIG. 7, the rechargeable battery according to the second exemplary embodiment has the same structure as the rechargeable battery according to the aforementioned first exemplary embodiment, except for a conductive member 210. Therefore, a repeated description of the same structure will be omitted.

The conductive member 210 includes a plurality of conductive plates. That is, the conductive member 210 includes first conductive plates 211 and 212 that are disposed at outermost sides, second conductive plates 213 that are disposed between the first conductive plates 211 and 212, and a third conductive plate 214 that is disposed between the second conductive plates 213.

The unit cells are disposed between the first conductive plates 211 and 212 and the second conductive plates 213, and between the second conductive plates 213 and the third conductive plate 214. The first conductive plates 211 and 212, the second conductive plates 213, and the third conductive plate 214 are formed to be rectangular. The first conductive plates 211 and 212, the second conductive plates 213, and the third conductive plate 214 are formed of a metal having electrical conductivity, and opposite surfaces thereof are attached, e.g., coated, with insulating films 210a and 210b.

In detail, the first conductive plates 211 and 212 are electrically connected to respective adjacent second conductive plates 213 through a lateral side-connecting plate 216, and the second conductive plates 213 are electrically connected to the third conductive plate 214 through the lateral side-connecting plate 216. For example, as illustrated in FIG. 7, the third conductive plate 214 may be between two adjacent second conductive plates 213, and each second conductive plate 213 may be between the third conductive plate 214 and a corresponding one of the first conductive plates 211 and 212.

Heights of the lateral side-connecting plates 216, e.g., along the z-axis, are formed to be smaller than those of the first conductive plates 211 and 212, such that heat can be generated through the lateral side-connecting plates 216 if the short-circuit current flows. The heights of the lateral side-connecting plates 216 may be formed to be one-third to one-twentieth of the height of the first conductive plates 211 and 212. The lateral side-connecting plates 216 may be disposed at the center of the first conductive plates 211 and 212 and the second conductive plate 213 in a height direction thereof, e.g., the lateral side-connecting plates 216 may be centered along sides of the first conductive plates 211 and 212 (z-axis).

According to example embodiments, when the short-circuit current flows, i.e., even if a large amount of heat is generated, the large amount of heat is generated outside the unit cells through the lateral side-connecting plates 216. Therefore, the amount of heat inside the unit cells is decreased.

Further, avoidance holes 213a are formed at respective centers of the second conductive plates 213, such that the second conductive plates 213 do not directly contact the conductive foreign object, i.e., if the conductive foreign object penetrates therein. Each avoidance hole 213a is formed to have a substantially rectangular cross-section and an area corresponding to about 50% to about 90% of the area of the second conductive plate 213.

The lateral side-connecting plate 216 is formed with a terminal connecting portion 217 that is fixed to the negative terminal of the unit cell, and the first conductive plate 212 is formed with a short-circuit connecting portion 215 that is disposed above the short-circuit member of the unit cell.

The first conductive plates 211 and 212 and the third conductive plate 214 may directly contact the conductive foreign object, if the conductive foreign object penetrates therein. However, the second conductive plates 213 do not directly contact the conductive foreign object. Therefore, the current of the unit cells that are disposed adjacent to the second conductive plates 213 may be easily discharged through the first conductive plates 211 and 212 or the third conductive plate 214.

In FIG. 7, a configuration in which two second conductive plates 213 are provided is exemplarily illustrated. However, embodiments are not limited thereto, and at least one second conductive plate 213 can be provided to be disposed between the first conductive plates 211 and 212 and the third conductive plate 214.

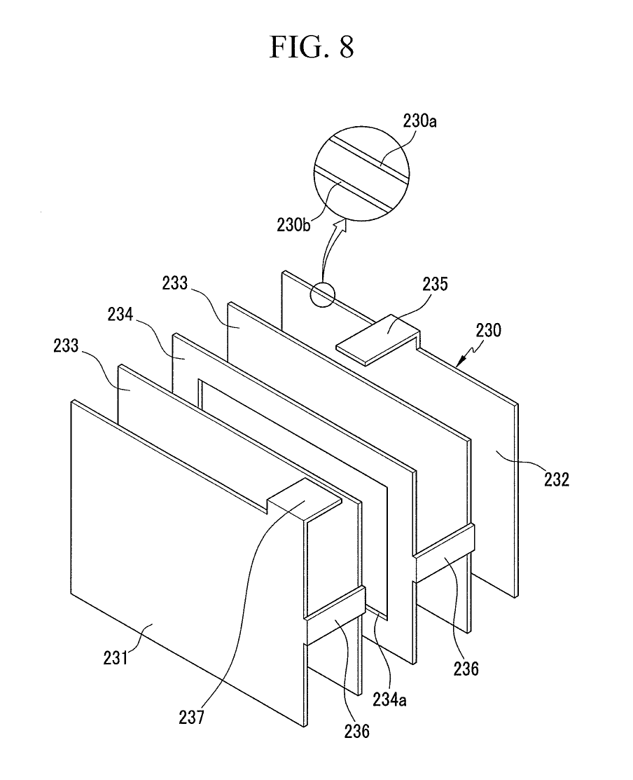

FIG. 8 illustrates a perspective view of a conductive member according to a third exemplary embodiment.

Referring to FIG. 8, the rechargeable battery according to the third exemplary embodiment has the same structure as the rechargeable battery according to the aforementioned second exemplary embodiment, except for a conductive member 230. Therefore, a repeated description of the same structure will be omitted.

The conductive member 230 includes a plurality of conductive plates, i.e., first conductive plates 231 and 232 that are disposed at outermost sides, second conductive plates 233 that are disposed between the first conductive plates 231 and 232, and a third conductive plate 234 that is disposed between the second conductive plates 233. The unit cells are disposed between the first conductive plates 231 and 232 and the second conductive plates 233, and between the second conductive plates 233 and the third conductive plate 234.

The first conductive plates 231 and 232, the second conductive plates 233, and the third conductive plate 234 are formed to be rectangular. The first conductive plates 231 and 232, the second conductive plates 233, and the third conductive plate 234 are formed of a metal having electrical conductivity, and opposite surfaces thereof are attached with insulating films 230a and 230b.

The first conductive plates 231 and 232 are electrically connected to the second conductive plates 233 through a lateral side-connecting plate 236, and the second conductive plate 233 is electrically connected to the third conductive plate 234 through the lateral side-connecting plate 236. Heights of the lateral side-connecting plate 236 are formed to be smaller than those of the first conductive plates 231 and 232, such that heat can be generated, e.g., dissipated, through the lateral side-connecting plates 236 when the short-circuit current flows. The heights of the lateral side-connecting plates 236 may be formed to be one-third to one-twentieth of the height of the first conductive plates 231 and 232. The lateral side-connecting plates 236 may be disposed at centers of the first conductive plates 231 and 232 and the second conductive plate 233 in a height direction thereof.

Further, avoidance holes 234a are formed at centers of the second conductive plates 234 such that the second conductive plates 234 do not directly contact the conductive foreign object when the conductive foreign object penetrates therein. Each avoidance hole 234a may be formed to have, e.g., a substantially rectangular, cross-section and an area corresponding to about 50% to about 90% of the area of the third conductive plate 234.

Among the first conductive plates 231 and 232, one conductive plate 231 is formed with a terminal connecting portion 237 that protrudes to be fixed to the negative terminal of the unit cell, and the other conductive plate 232 is formed with a short-circuit connecting portion 235 that is disposed above the short-circuit member of the unit cell. The conductive member 230 is positively charged through the terminal connecting portion 237. The short-circuit member and the short-circuit connecting portion 235 contact each other to cause an external short-circuit when the short-circuit member is inversely deformed.

The conductive foreign object contacts the positively charged case, if the conductive foreign object penetrates therein. Further, the conductive foreign object directly contacts the first conductive plates 231 and 232 and the second conductive plates 233. However, the third conductive plate 234 does not directly contact the conductive foreign object.

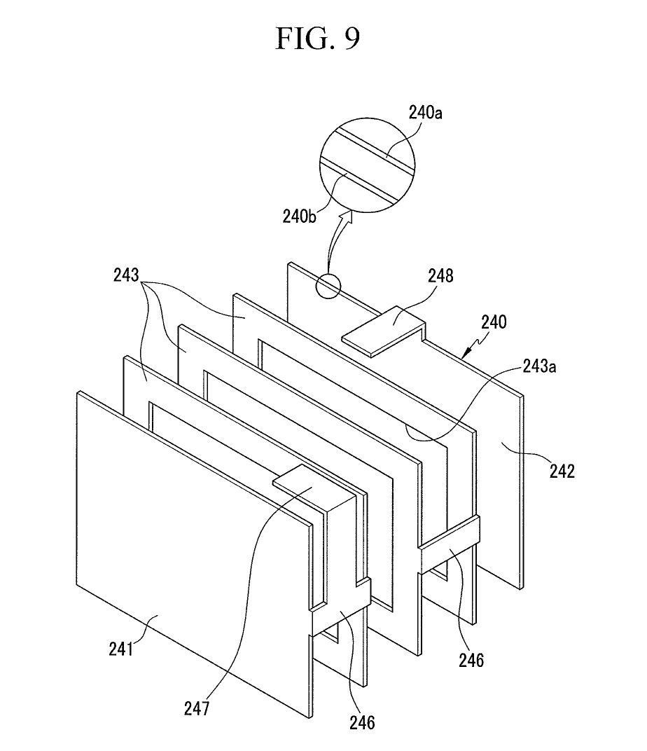

FIG. 9 illustrates a perspective view of a conductive member according to a fourth exemplary.

Referring to FIG. 9, since the rechargeable battery according to the current fourth exemplary embodiment has the same structure as the rechargeable battery according to the aforementioned first exemplary embodiment, except for a conductive member 240. Therefore, a repeated description of the same structure will be omitted.

The conductive member 240 includes a plurality of conductive plates, i.e., first conductive plates 241 and 242 that are disposed at outermost sides, and second conductive plates 243 that are disposed between the first conductive plates 241 and 242. The unit cells are disposed between the first conductive plates 241 and 242 and the second conductive plates 243, and between the second conductive plates 243.

The first conductive plates 241 and 242 and the second conductive plates 243 are formed to be rectangular. The first conductive plates 241 and 242 and the second conductive plates 243 are formed of a metal having electrical conductivity, and opposite surfaces thereof are attached, e.g., coated, with insulating films 240a and 240b.

The first conductive plates 241 and 242 are electrically connected to the second conductive plates 243 through lateral side-connecting plates 246, and heights of the lateral side-connecting plates 246 are formed to be smaller than those of the first conductive plates 241 and 242, such that heat can be generated, e.g., dissipated, through the lateral side-connecting plates 246 when the short-circuit current flows. For example, the heights of the lateral side-connecting plate 246 may be formed to be one-third to one-twentieth of the height of the first conductive plates 241 and 242. The lateral side-connecting plates 246 may be disposed at centers of the first conductive plates 241 and 242 and the second conductive plates 243 in a height direction thereof.

Further, avoidance holes 243a may be formed centers of the second conductive plates 243, such that the second conductive plates 243 do not directly contact the conductive foreign object when the conductive foreign object penetrates therein. Each avoidance hole 243a may be formed to have, e.g., a substantially rectangular, cross-section and an area corresponding to about 50% to about 90% of the area of the second conductive plate 243. The avoidance hole 243a formed as such may allow the second conductive plates 243 to support the unit cells and prevent the weight of the rechargeable battery module from excessively increasing.

The lateral side-connecting plate 246 is formed with a terminal connecting portion 247 that protrudes to be fixed to the negative terminal of the unit cell, and the first conductive plate 242 is formed with a short-circuit connecting portion 248 that is disposed above the short-circuit member of the unit cell. The conductive member 240 is negatively charged through the terminal connecting portion 247, and the short-circuit member contacts the short-circuit connecting portion 248 to cause the external short circuit. The conductive foreign object contacts the case to be positively charged when the conductive foreign object penetrates therein, and the conductive foreign object directly contacts the first conductive plates 241 and 242.

By way of summation and review, according to example embodiments, a rechargeable battery module includes a conductive member that is positioned around and between battery cells in the battery module and is electrically connected to an electrode terminal of one of the battery cells. As such, if a conductive foreign object penetrates through the conductive member to enter the unit cells, an outermost disposed portion of the conductive member is short-circuited with the case outside the unit cells so as to discharge the current charged in the unit cells. Accordingly, the rechargeable battery module can be prevented from running the risk of ignition, and thus safety thereof can be improved.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A rechargeable battery module, comprising:
a plurality of unit cells adjacent to each other, each unit cell including a rechargeable battery with a first electrode terminal, a second electrode terminal, and a case electrically connected to the first electrode terminal; and
a conductive member electrically connected to a second electrode terminal of one of the unit cells of the plurality of unit cells, the conductive member including first conductive plates at outermost sides of the unit cells and a plurality of second conductive plates between the unit cells.

2. The rechargeable battery module as claimed in claim 1, wherein the conductive member further comprises lateral side-connecting plates, the lateral side-connecting plates being bent from and connecting to the first and second conductive plates.

3. The rechargeable battery module as claimed in claim 2, wherein the lateral side-connecting plates include a terminal connecting portion, the terminal connecting portion protruding upward and being fixed to the second electrode terminal.

4. The rechargeable battery module as claimed in claim 2, wherein the lateral side-connecting plates connect the first and second conductive plates in series.

5. The rechargeable battery module as claimed in claim 2, wherein the first conductive plates include a terminal connecting portion, the terminal connecting portion protruding upward and being fixed to the second electrode terminal.

6. The rechargeable battery module as claimed in claim 1, further comprising insulating layers on surfaces of the first conductive plates that face each unit cell.

7. The rechargeable battery module as claimed in claim 1, further comprising insulating layers on opposite surfaces of the second conductive plates.

8. The rechargeable battery module as claimed in claim 1, wherein at least one of the second conductive plates includes an avoidance hole.

9. The rechargeable battery module as claimed in claim 1, wherein the conductive member further comprises a third conductive plate between the second conductive plates, only the second conductive plates among the second and third conductive plates including avoidance holes.

10. The rechargeable battery module as claimed in claim 1, wherein the conductive member further comprises a third conductive plate between the second conductive plates, only the third conductive plates among the second and third conductive plates including avoidance holes.

11. The rechargeable battery module as claimed in claim 1, wherein the unit cells include at least one first unit cell with an inversely deformed short-circuit member according to varying internal pressure, and at least one second unit cell without the short-circuit member.

12. The rechargeable battery module as claimed in claim 11, wherein the conductive member further comprises a short-circuit connecting portion protruding from one of the first conductive plates above the short-circuit member of the at least one first unit cell, the short-circuit connecting portion contacting the short-circuit member of the at least one first unit cell when the short-circuit member is deformed.

13. The rechargeable battery module as claimed in claim 12, wherein a surface of the short-circuit connecting portion facing the short-circuit member includes an insulating layer, the insulating layer including an opening exposing the short-circuit connecting portion.

14. The rechargeable battery module as claimed in claim 2, wherein heights of the lateral side-connecting plates are smaller than heights of the first conductive plates.
